(19) United States
(12) Patent Application Publication
(10) Pub. No.: US 2009/0160103 A1
(43) Pub. Date: Jun. 25, 2009

(54) FLAMEPROOFED IMPACT-MODIFIED POLYCARBONATE COMPOSITION

(75) Inventors: Thomas ECKEL, Dormagen (DE); Vera BUCHHOLZ, Koln (DE); Eckhard WENZ, Koln (DE)

Correspondence Address: Baker Donelson Bearman, Caldwell & Berkowitz, PC, 555 Eleventh Street, NW, Sixth Floor, Washington, DC, 20004, US

(73) Assignee: Bayer MaterialScience AG, Leverkusen (DE)

(21) Appl. No.: 12/338,026

(22) Filed: Dec. 18, 2008

(30) Foreign Application Priority Data
Dec. 20, 2007 (DE) 102007061762.5

(51) Int. Cl. C08K 3/32; B29C 45/00; B29C 49/00; B29C 51/00

(52) U.S. Cl. 264/572; 524/414; 264/328.1; 264/331.21

(57) ABSTRACT

The present invention relates to a polycarbonate composition comprising
A) 58 to 99.6 parts by wt. (in each case based on the sum of the parts by weight of components A+B+C) of aromatic polycarbonate and/or aromatic polyester carbonate,
B) 0.5 to 12 parts by wt. (in each case based on the sum of the parts by weight of components A+B+C) of rubber-modified graft polymer prepared in the bulk, solution or bulk-suspension polymerization process, and
C) 0.1 to 30 parts by wt. (in each case based on the sum of the parts by weight of components A+B+C) of a salt of a phosphinic acid.

A composition of the present invention is distinguished by an optimum combination of high heat distortion temperature, good flameproofing, excellent mechanical properties and a good resistance to hydrolysis. The present invention further relates to the use of the polycarbonate compositions for the production of shaped articles and the shaped articles themselves.

### CROSS REFERENCE TO RELATED APPLICATIONS

This application claims priority to DE 102007061762.5 filed Dec. 20, 2007, the content of which is incorporated herein by reference in its entirety.

### BACKGROUND OF THE INVENTION

1. Field of the Invention

The present invention relates generally to a polycarbonate composition which comprises a rubber-containing graft polymer prepared by the bulk polymerization process and a salt of a phosphinic acid, as well as to the use of the polycarbonate compositions for the production of shaped articles and the shaped articles themselves.

2. Description of Related Art

WO-A 2005/044906 discloses thermoplastic moulding compositions comprising at least one metal salt of hypophosphoric acid and at least one aromatic polycarbonate resin and a mixture thereof with a styrene-containing graft copolymer resin having a rubber content of 5-15%. The contents of the styrene-containing graft copolymer are 10-40 wt. %. The moulding compositions obtained are distinguished by good flame resistance, high heat stability under processing conditions and good weather resistance. Because of the low rubber content, other properties, in particular mechanical properties, are at a low level.

WO-A 1999/57192 describes thermoplastic moulding compositions comprising 5-96 wt. % of a polyester or polycarbonate, 1-30 wt. % of a phosphinic acid salt and/or of a diphosphinic acid salt and/or polymers thereof, 1-30 wt. % of at least one organic phosphorus-containing flameproofing agent, and possible further additives.

DE-A 102004049342 discloses thermoplastic moulding compositions comprising 10-98 wt. % of thermoplastic polymer, 0.01-50 wt. % of highly branched polycarbonate or highly branched polyester or mixtures thereof, 1-40 wt. % of halogen-free flameproofing agent chosen from the group of P-containing or N-containing compounds or of P-N condensates or mixtures thereof, and possible further additives.

JP-A 2001-335699 describes flameproofed resin compositions comprising two or more thermoplastic resins chosen from styrene resin, aromatic polyester resin, polyamide resin, polycarbonate resin and polyphenylene ether resin and one or more (in)organic phosphinic acid salts, and possible further additives.

JP-A 2001-261973 (Daicel Chemical Industries Ltd.) describes compositions of thermoplastic resins and (in)organic phosphinic acid salts. A combination of PBT, calcium phosphinate and PTFE is given as an example.

JP-A 2002-161211 discloses compositions of thermoplastic resins and flameproofing agents, such as salts of phosphinic and phosphoric acid and derivatives thereof. A combination of PBT, ABS, polyoxyphenylene, calcium phosphinate, an organophosphate and glass fibres is given as an example.

Flameproofing agents which are conventional according to the prior art for polycarbonate/ABS blends are organic aromatic phosphates. These compounds can be in a low molecular weight form, in the form of a mixture of various oligomers or in the form of a mixture of oligomers with low molecular weight compounds (e.g. WO-A 99/16828 and WO-A 00/31173). The good activity as flameproofing agents is counteracted adversely by the highly plasticizing action of these compounds on the polymeric constituents, so that the heat distortion temperature of these moulding compositions is not satisfactory for many uses.

### SUMMARY OF THE INVENTION

An object of the present invention was to provide impact-modified polycarbonate moulding compositions having an optimum combination of high heat distortion temperature, good flameproofing, excellent mechanical properties and a good resistance to hydrolysis.

It has now been found, surprisingly, that moulding compositions or compositions comprising A) a polycarbonate, B) a rubber-modified graft polymer prepared by a bulk, solution and/or bulk-suspension polymerization process and C) a salt of a phosphinic acid have the desired profile of properties.

It has thus been found, surprisingly, that a composition comprising
A) 58 to 99.6 parts by wt., preferably 76 to 98 parts by wt., particularly preferably 80 to 90 parts by wt. (in each case based on the sum of the parts by weight of components A+B+C) of an aromatic polycarbonate and/or an aromatic polyester carbonate,
B) 0.5 to 12 parts by wt., preferably 1 to 9 parts by wt., particularly preferably 3 to 8 parts by wt. (in each case based on the sum of the parts by weight of components A+B+C) of rubber-modified graft polymer prepared by a bulk, solution and/or bulk-suspension polymerization process,
C) 0.1 to 30 parts by wt., preferably 1 to 15 parts by wt., particularly preferably 7 to 12 parts by wt. (in each case based on the sum of the parts by weight of components A+B+C) of a salt of a phosphinic acid,
D) 0 to 20 parts by wt. (based on the sum of the parts by weight of components A+B+C=100) of rubber-free vinyl (co)polymer and/or polyalkylene terephthalate, however in many embodiments, preferably the composition is free from rubber-free vinyl (co)polymer and/or polyalkylene terephthalate,
E) 0 to 50 parts by wt., preferably 0.5 to 25 parts by wt. (in each case based on the sum of the parts by weight of components A+B+C=100) of at least one additive,
   wherein all the parts by weight stated in the present application are standardized such that the sum of the parts by weight of components A+B+C in the composition is 100, achieve the abovementioned technical object.

Other products and methods in accordance with the present invention are provided in the detailed description and claims that follow below. Additional objects, features, and advantages will be sent forth in the description that follows, and in part, will be obvious from the description, or may be learned by practice of the invention. The objects, features, and advantages may be realized and obtained by means of the instrumentalities and combination particularly pointed out in the appended claims.

### DETAILED DESCRIPTION OF A PREFERRED EMBODIMENT

By having too high a content of component B, a disadvantage could arise that the burning properties and the heat distortion temperature (Vicat B) could be impaired (see Comparison Example 2).

### Component A

Aromatic polycarbonates and/or aromatic polyester carbonates according to component A which are suitable according to the invention are known from the literature or can be prepared by processes known from the literature (for the preparation of aromatic polycarbonates see, for example, Schnell, “Chemistry and Physics of Polycarbonates”, Interscience Publishers, 1964 and DE-AS 1 495 626, DE-A 2 232 877, DE-A 2 703 376, DE-A 2 714 544, DE-A 3 000 610 and DE-A 3 832 396; for the preparation of aromatic polyester carbonates e.g. DE-A 3 077 934).

Aromatic polycarbonates are prepared e.g. by reaction of diphenols with carbonic acid halides, preferably phosgene, and/or with aromatic dicarboxylic acid dihalides, preferably benzenedicarboxylic acid dihalides, by the interfacial process, optionally using chain terminators, for example monophenols, and optionally using branching agents which are trifunctional or more than trifunctional, for example triphenols or tetraphenols. A preparation via a melt polymerization process by reaction of diphenols with, for example, diphenyl carbonate is likewise possible.

Diphenols for the preparation of the aromatic polycarbonates and/or aromatic polyester carbonates are preferably those of the formula (I)

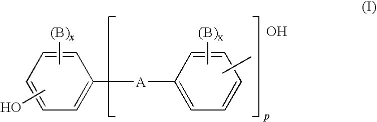

wherein
A is a single bond, C₁ to C₅-alkylene, C₂ to C₅-alkylidene, C₅ to C₆-cycloalkylidene, —O—, —SO—, —CO—, —S—, —SO₂—, C₆ to C₁₂-arylene, on to which further aromatic rings optionally containing hetero atoms can be fused,
   or a radical of the formula (II) or (III)

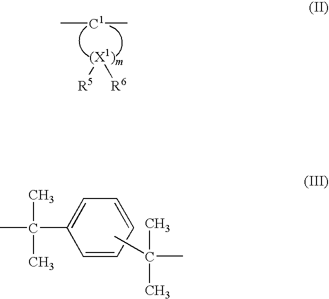

B is in each case C₁ to C₁₂-alkyl, preferably methyl, or halogen, preferably chlorine and/or bromine,
x is in each case independently of one another 0, 1 or 2,
p is 1 or 0, and
R⁵ and R⁶ can be chosen individually for each X¹ and independently of one another denote hydrogen or C₁ to C₆-alkyl, preferably hydrogen, methyl or ethyl,
X¹ denotes carbon and
m denotes an integer from 4 to 7, preferably 4 or 5, with the proviso that on at least one atom X¹, R⁵ and R⁶ are simultaneously alkyl.

Preferred diphenols include hydroquinone, resorcinol, dihydroxydiphenols, bis-(hydroxyphenyl)-C₁-C₅-alkanes, bis-(hydroxyphenyl)-C₅-C₆-cycloalkanes, bis-(hydroxyphenyl)ethers, bis-(hydroxyphenyl) sulfoxides, bis-(hydroxyphenyl) ketones, bis-(hydroxyphenyl) sulfones and α,α-bis-(hydroxyphenyl)-diisopropyl-benzenes and derivatives thereof, which can be brominated on the nucleus and/or chlorinated on the nucleus.

Particularly preferred diphenols are 4,4′-dihydroxydiphenyl, bisphenol-A, 2,4-bis(4-hydroxyphenyl)-2-methylbutane, 1,1-bis-(4-hydroxyphenyl)-cyclohexane, 1,1-bis-(4-hydroxyphenyl)-3,3,5-trimethylcyclohexane, 4,4′-dihydroxydiphenyl sulfide, 4,4′-dihydroxydiphenyl sulfone and di- and tetrabrominated or chlorinated derivatives thereof, such as, for example, 2,2-bis(3-chloro-4-hydroxyphenyl)-propane, 2,2-bis-(3,5-dichloro-4-hydroxyphenyl)-propane or 2,2-bis-(3,5-dibromo-4-hydroxyphenyl)-propane. 2,2-Bis-(4-hydroxyphenyl)-propane (bisphenol A) is particularly preferred.

The diphenols can be employed individually or as any desired mixtures. The diphenols are known from the literature or obtainable by processes known from the literature.

Chain terminators which are suitable for the preparation of the thermoplastic aromatic polycarbonates are, for example, phenol, p-chlorophenol, p-tert-butylphenol or 2,4,6-tribromophenol, but also long-chain alkylphenols, such as 4-[2-(2,4,4-trimethylpentyl)]-phenol, 4-(1,3-tetramethylbutyl)-phenol according to DE-A 2 842 005 or monoalkylphenols or dialkylphenols having a total of 8 to 20 carbon atoms in the alkyl substituents, such as 3,5-di-tert-butylphenol, p-iso-octylphenol, p-tert-octylphenol, p-dodecylphenol and 2-(3,5-dimethylheptyl)-phenol and 4-(3,5-dimethylheptyl)-phenol. The amount of chain terminators to be employed is in general between 0.5 mol % and 10 mol %, based on the sum of the moles of the particular diphenols employed.

The thermoplastic aromatic polycarbonates advantageously have average weight-average molecular weights (M_{w}, measured e.g. by GPC, ultracentrifuge or scattered light measurement) of from 10,000 to 200,000 g/mol, preferably 15,000 to 80,000 g/mol, particularly preferably 24,000 to 32,000 g/mol.

The thermoplastic aromatic polycarbonates can be branched in a known manner, and in particular preferably by incorporation of preferably from 0.05 to 2.0 mol %, based on the sum of the diphenols employed, of compounds which are trifunctional or more than trifunctional, for example those having three and more phenolic groups.

Both homopolycarbonates and copolycarbonates are suitable. Advantageously 1 to 25 wt. %, preferably 2.5 to 25 wt. %, based on the total amount of diphenols to be employed, of polydiorganosiloxanes having hydroxyaryloxy end groups can also be employed for the preparation of the copolycarbonates according to the invention according to component A. These are known (U.S. Pat. No. 3,419,634) and can be prepared by processes known from the literature. The preparation of copolycarbonates containing polydiorganosiloxane is described in DE-A 3 334 782.

Preferred polycarbonates include, in addition to bisphenol A homopolycarbonates, copolycarbonates of bisphenol A with up to 15 mol %, based on the sum of the moles of diphenols, of other diphenols mentioned as preferred or particularly preferred, in particular 2,2-bis(3,5-dibromo-4-hydroxyphenyl)-propane.

Aromatic dicarboxylic acid dihalides for the preparation of aromatic polyester carbonates are preferably the diacid dichlorides of isophthalic acid, terephthalic acid, diphenyl ether 4,4′-dicarboxylic acid and of naphthalene-2,6-dicarboxylic acid.

Mixtures of the diacid dichlorides of isophthalic acid and of terephthalic acid in a ratio of between 1:20 and 20:1 are particularly preferred.

A carbonic acid halide, preferably phosgene, is additionally co-used as a bifunctional acid derivative in the preparation of polyester carbonates.

Possible chain terminators for the preparation of the aromatic polyester carbonates can be, in addition to the monophenols already mentioned, also chlorocarbonic acid esters thereof and the acid chlorides of aromatic monocarboxylic acids, which can optionally be substituted by C₁ to C₂₂-alkyl groups or by halogen atoms, and aliphatic C₂ to C₂₂-monocarboxylic acid chlorides.

The amount of chain terminators is in each case suitably 0.1 to 10 mol %, based on the moles of diphenol in the case of the phenolic chain terminators and on the moles of dicarboxylic acid dichloride in the case of monocarboxylic acid chloride chain terminators.

The aromatic polyesters carbonates can also optionally comprise incorporated aromatic hydroxycarboxylic acids.

The aromatic polyester carbonates can be either linear or branched in a known manner (in this context see DE-A 2 940 024 and DE-A 3 007 934).

Branching agents which can be used include, for example, carboxylic acid chlorides which are trifunctional or more than trifunctional, such as trimesic acid trichloride, cyanuric acid trichloride, 3,3′,4,4′-benzophenone-tetracarboxylic acid tetrachloride, 1,4,5,8-naphthalenetetracarboxylic acid tetrachloride or pyromellitic acid tetrachloride, in amounts of from 0.01 to 1.0 mol-% (based on the dicarboxylic acid dichlorides employed), or phenols which are trifunctional or more than trifunctional, such as phloroglucinol, 4,6-dimethyl-2,4,6-tri-(4-hydroxyphenyl)-hept-2-ene, 4,6-dimethyl-2, 4-6-tri-(4-hydroxyphenyl)-heptane, 1,3,5-tri-(4-hydroxyphenyl)-benzene, 1,1,1-tri-(4-hydroxyphenyl)-ethane, tri-(4-hydroxyphenyl)-phenylmethane, 2,2-bis[4,4-bis(4-hydroxy-phenyl)-cyclohexyl]-propane, 2,4-bis(4-hydroxyphenyl-isopropyl)-phenol, tetra-(4-hydroxyphenyl)-methane, 2,6-bis(2-hydroxy-5-methyl-benzyl)-4-methyl-phenol, 2-(4-hydroxyphenyl)-2-(2,4-dihydroxyphenyl)-propane, tetra-(4-[4-hydroxyphenyl-isopropyl]-phenoxy)-methane or 1,4-bis[4,4′-dihydroxytriphenyl)-methyl]-benzene, in amounts of preferably from 0.01 to 1.0 mol %, based on the diphenols employed. Phenolic branching agents can be initially introduced with the diphenols if desired, and acid chloride branching agents can be introduced together with the acid dichlorides.

The content of carbonate structural units in the thermoplastic aromatic polyester carbonates can vary as desired. The content of carbonate groups is preferably up to 100 mol %, in particular up to 80 mol %, particularly preferably up to 50 mol %, based on the sum of ester groups and carbonate groups. Both the ester and the carbonate content of the aromatic polyester carbonates can be present in the polycondensate in any form such as in the form of blocks and/or randomly distributed.

The relative solution viscosity (ηᵣₑₗ) of the aromatic polycarbonates and polyester carbonates is suitably in the range of 1.18 to 1.4, preferably 1.20 to 1.32 (measured on solutions of 0.5 g of polycarbonate or polyester carbonate in 100 ml of methylene chloride solution at 25° C.).

The thermoplastic aromatic polycarbonates and polyester carbonates can be employed by themselves or in any desired mixture.

### Component B

The rubber-modified graft polymer B suitably includes a random (co)polymer of monomers according to B.1.1 and/or B.1.2 and a rubber B.2 grafted with the random (co)polymer of B.1.1 and/or B.1.2, the preparation of B being carried out in a known manner by a bulk or solution or bulk-suspension polymerization process, as described e.g. in U.S. Pat. No. 3,243,481, U.S. Pat. No. 3,509,237, U.S. Pat. No. 3,660,535, U.S. Pat. No. 4,221,833 and U.S. Pat. No. 4,239,863.

Examples of suitable monomers B.1.1 include styrene, α-methylstyrene, styrenes substituted on the nucleus by halogen or alkyl, such as p-methylstyrene and p-chlorostyrene, and (meth)acrylic acid C₁-C₈-alkyl esters, such as methyl methacrylate, n-butyl acrylate and t-butyl acrylate. Examples of monomers B.1.2 include unsaturated nitriles, such as acrylonitrile and methacrylonitrile, (meth)acrylic acid C₁-C₈-alkyl esters, such as methyl methacrylate, n-butyl acrylate and t-butyl acrylate, derivatives (such as anhydrides and imides) of unsaturated carboxylic acids, such as maleic anhydride and N-phenylmaleimide, or mixtures thereof.

Preferred monomers B.1.1 can be chosen from at least one of the monomers styrene, α-methylstyrene and methyl methacrylate, and preferred monomers B.1.2 are chosen from at least one of the monomers acrylonitrile, maleic anhydride and methyl methacrylate.

Particularly preferred monomers are B.1.1 styrene and B.1.2 acrylonitrile.

Graft bases B.2 which are suitable for the graft polymers B are, for example, diene rubbers, diene/vinyl block copolymer rubbers, EP(D)M rubbers, that is to say those based on ethylene/propylene and optionally diene, and acrylate, polyurethane, silicone, chloroprene and ethylene/vinyl acetate rubbers and mixture of such rubbers, and silicone/acrylate composite rubbers in which the silicone and the acrylate components are linked to one another chemically (e.g. by grafting).

Preferred rubbers B.2 are diene rubbers (e.g. based on butadiene, isoprene etc.) or mixtures of diene rubbers or copolymers of diene rubbers or mixtures thereof with further copolymerizable monomers (e.g. according to B.1.1 and B.1.2), with the proviso that the glass transition temperature of component B.2 is below 10° C., preferably below −10° C. Pure polybutadiene rubber is particularly preferred.

Preferably, the graft polymer of components B.1 and B.2 has a core-shell structure, wherein component B.1 forms the shell (also called casing) and component B.2 forms the core (see e.g. Ullmann's Encyclopedia of Industrial Chemistry, VCH-Verlag, vol. A21, 1992, page 635 and page 656).

If necessary and if the rubber properties of component B.2 are not thereby impaired, component B can additionally also comprise small amounts, conventionally less than 5 wt. %, preferably less than 2 wt. %, based on B.2, of at least one ethylenically unsaturated monomer having a crosslinking action. Examples of such monomers having a crosslinking action include alkylene diol di(meth)-acrylates, polyester di-(meth)-acrylates, divinylbenzene, trivinylbenzene, triallyl cyanurate, allyl (meth)-acrylate, diallyl maleate and diallyl fumarate.

The rubber-modified graft polymer B can be obtained for example by a grafting polymerization of from 50 to 99, preferably 65 to 98, particularly preferably 75 to 95 parts by wt. of a mixture of 50 to 99, preferably 60 to 95 parts by wt. of monomers according to B.1.1 and 1 to 50, preferably 5 to 40 parts by wt. of monomers according to B.1.2 in the presence of from 1 to 50, preferably 2 to 35, particularly preferably 5 to 25 parts by wt. of the rubber component B.2. The grafting polymerization can advantageously be carried out by a bulk or solution or bulk-suspension polymerization process.

In the preparation of the rubber-modified graft polymers B, it is desirable that the rubber component B.2 be present in the mixture of the monomers B.1.1 and/or B.1.2 in dissolved form before the grafting polymerization. The rubber component B.2. therefore should preferably not be so highly crosslinked that a solution in B.1.1 and/or B.1.2 becomes impossible. Furthermore B.2 should preferably already be in the form of discrete particles at the start of the grafting polymerization. The particle morphology and increasing crosslinking of B.2 is important for the product properties of B, and it develops during in the course of the grafting polymerization (in this context see, for example, Ullmann, Encyclopädie der technischen Chemie, volume 19, p. 284 et seq., 4th edition 1980).

The random copolymer of B.1.1 and B.1.2 is conventionally present in the polymer B in part grafted onto or in the rubber B.2. Such a graft copolymer preferably forms discrete particles in the polymer B. The content of grafted-on or -in copolymer of B.1.1 and B.1.2 in the total copolymer of B.1.1 and B.1.2—(that is to say the grafting yield=weight ratio of the grafting monomers actually grafted to the grafting monomers used in total×100, stated in %)—should preferably be 2 to 40% in this context, more preferably 3 to 30%, particularly preferably 4 to 20%.

The average particle diameter of the resulting grafted rubber particles (determined by counting on electron microscopy photographs) is advantageously in the range of from 0.5 to 5 μm, preferably from 0.8 to 2.5 μm. The average particle size d₅₀ is the diameter above and below which in each case 50 wt. % of the particles lie. It can be determined by means of ultracentrifuge measurement (W. Scholtan, H. Lange, Kolloid, Z. und Z. Polymere 250 (1972), 782-796) or by counting on electron microscopy photographs. The graft polymer according to component B preferably has a core-shell structure as discussed supra.

In a preferred embodiment, the graft polymer according to component B) can comprise a graft polymer which is prepared by a bulk, solution and/or bulk-suspension polymerization process and has a rubber content (corresponds to the content of component B.2 in the graft polymer) of from 16 to 25 wt. %, preferably from 17 to 19 wt. %, and a grafted shell which contains, in each case based on the monomers of the grafted shell, 22 to 27 wt. % of at least one of the monomers according to B.1.2 and 73 to 78 wt. % of at least one of the monomers according to B.1.1. The graft polymer very preferably contains a butadiene/styrene block copolymer rubber as the core and a shell of styrene (B.1.1) and acrylonitrile (B.1.2). The graft polymer has a gel content (measured in acetone) of preferably from 20 to 30 wt. %, more preferably from 22 to 26 wt. %. The gel content of the graft polymers is determined at 25° C. in a suitable solvent (M. Hoffmann, H. Kromer, R. Kuhn, Polymeranalytik I und II, Georg Thieme-Verlag, Stuttgart 1977).

Graft polymers prepared by the emulsion polymerization process have the disadvantage, compared with graft polymers according to the invention, that the resistance to hydrolysis of emulsion polymerized graft polymers is often at a level which may be inadequate for many uses. The conventionally high rubber content of emulsion graft polymers may also lead to an impairment of the burning properties in some cases. As such, emulsion polymerization can be undesirable in some embodiments of the present invention.

If the graft polymer according to the invention contains a rubber content of less than about 16 wt. %, this may present the disadvantage that the mechanical properties, in particular the notched impact strength, and the resistance to chemicals, to be at a level which may be inadequate for many uses.

### Component C

The salt of a phosphinic acid (component C) in the context according to the invention is to be understood as meaning the salt of a phosphinic acid with any desired metal cation. Mixtures of salts which differ in their metal cation can also be employed. The metal cations are the cations of metals of main group 1 (alkali metals, preferably Li⁺, Na⁺, K⁺), of main group 2 (alkaline earth metals; preferably Mg²⁺, Ca²⁺, Sr²⁺, Ba²⁺, particularly preferably Ca²⁺) or of main group 3 (elements of the boron group; preferably Al³⁺) and/or of subgroup 2, 7 or 8 (preferably Zn²⁺, Mn²⁺, Fe²⁺, Fe³⁺) of the periodic table.

A salt or a mixture of salts of a phosphinic acid of the formula (IV) is preferably employed

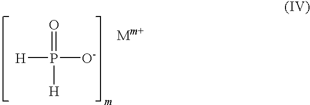

wherein M^{m+} is a metal cation of main group 1 (alkali metals; m=1), main group 2 (alkaline earth metals; m=2) or of main group 3 (m=3) or of subgroup 2, 7 or 8 (wherein m denotes an integer from 1 to 6, preferably 1 to 3 and particularly preferably 2 or 3) of the periodic table.

Particularly preferably, in formula (IV)

for m=1 the metal cations M⁺=Li⁺, Na⁺, K⁺,
for m=2 the metal cations M²⁺=Mg²⁺, Ca²⁺, Sr²⁺, Ba²⁺ and
for m=3 the metal cations M³⁺=Al³⁺,
Ca²⁺ (m=2) and Al³⁺ (m=3) are very preferred.

In a preferred embodiment, the average particle size d₅₀ of the phosphinic acid salt (component C) is preferably less than 80 μm, more preferably less than 60 μm, and d₅₀ is particularly preferably from 10 μm to 55 μm. The average particle size d₅₀ is the diameter above and below which in each case 50 wt. % of the particles lie. Mixtures of salts which differ in their average particle size d₅₀ can also be employed if desired for any reason.

These particle size d₅₀ requirements of the phosphinic acid salt are in each case associated with the technical effect that the flameproofing efficiency of the phosphinic acid salt is increased.

The phosphinic acid salt can be employed either by itself and/or in combination with other phosphorus-containing flameproofing agents. The compositions according to the invention are preferably free from phosphorus-containing flameproofing agents chosen from the group of mono- and oligomeric phosphoric and phosphonic acid esters, phosphonate-amines and phosphazenes. These other phosphorus-containing flameproofing agents such as mono- and oligomeric phosphoric and phosphonic acid esters have a negative effect (when compared with phosphinic acid salts) with

### Component D

Component D is optional and can include one or more thermoplastic vinyl (co)polymers D.1 and/or polyalkylene terephthalates D.2.

Suitable vinyl (co)polymers D.1, if employed, include polymers of at least one monomer from the group of vinylaromatics, vinyl cyanides (unsaturated nitriles), (meth)acrylic acid (C₁-C₈)-alkyl esters, unsaturated carboxylic acids and derivatives (such as anhydrides and imides) of unsaturated carboxylic acids. (Co)polymers which are suitable in particular are those of
D.1.1 50 to 99, preferably 60 to 80 parts by wt. of vinylaromatics and/or vinylaromatics substituted on the nucleus, such as styrene, α-methylstyrene, p-methylstyrene and p-chlorostyrene, and/or (meth)acrylic acid (C₁-C₈)-alkyl esters, such as methyl methacrylate and ethyl methacrylate, and
D.1.2 1 to 50, preferably 20 to 40 parts by wt. of vinyl cyanides (unsaturated nitriles), such as acrylonitrile and methacrylonitrile, and/or (meth)acrylic acid (C₁-C₈)-alkyl esters, such as methyl methacrylate, n-butyl acrylate and t-butyl acrylate, and/or unsaturated carboxylic acids, such as maleic acid, and/or derivatives, such as anhydrides and imides, of unsaturated carboxylic acids, for example maleic anhydride and N-phenylmaleimide.

The vinyl (co)polymers D.1 are resinous, thermoplastic and rubber-free. The copolymer of D.1.1 styrene and D.1.2 acrylonitrile is particularly preferred.

The (co)polymers according to D.1 are known and can be prepared, for example, by free-radical polymerization, in particular by emulsion, suspension, solution or bulk polymerization. The (co)polymers preferably have average molecular weights Mw (weight-average, determined by light scattering or sedimentation) of between 15,000 and 200,000.

The polyalkylene terephthalates of component D.2 can be, for example, reaction products of aromatic dicarboxylic acids or their reactive derivatives, such as dimethyl esters or anhydrides, and aliphatic, cycloaliphatic or araliphatic diols, and mixtures of these reaction products.

Preferred polyalkylene terephthalates preferably contain at least 80 wt. %, more preferably at least 90 wt. %, based on the dicarboxylic acid component, of terephthalic acid radicals and preferably at least 80 wt. %, more preferably at least 90 wt. %, based on the diol component, of radicals of ethylene glycol and/or butane-1,4-diol.

The preferred polyalkylene terephthalates can contain, in addition to terephthalic acid radicals, up to 20 mol %, preferably up to 10 mol % of radicals of other aromatic or cycloaliphatic dicarboxylic acids having 8 to 14 C atoms or aliphatic dicarboxylic acids having 4 to 12 C atoms, such as e.g. radicals of phthalic acid, isophthalic acid, naphthalene-2,6-dicarboxylic acid, 4,4′-diphenyldicarboxylic acid, succinic acid, adipic acid, sebacic acid, azelaic acid and cyclohexanediacetic acid.

The preferred polyalkylene terephthalates can contain, in addition to radicals of ethylene glycol or butane-1,4-diol, up to 20 mol %, preferably up to 10 mol % of other aliphatic diols having 3 to 12 C atoms or cycloaliphatic diols having 6 to 21 C atoms, e.g. radicals of propane-1,3-diol, 2-ethylpropane-1,3-diol, neopentyl glycol, pentane-1,5-diol, hexane-1,6-diol, cyclohexane-1,4-dimethanol, 3-ethylpentane-2,4-diol, 2-methylpentane-2,4-diol, 2,2,4-trimethylpentane-1,3-diol, 2-ethylhexane-1,3-diol, 2,2-diethylpropane-1,3-diol, hexane-2,5-diol, 1,4-di-(β-hydroxyethoxy)-benzene, 2,2-bis-(4-hydroxycyclohexyl)-propane, 2,4-dihydroxy-1,1,3,3-tetramethyl-cyclobutane, 2,2-bis-(4-β-hydroxyethoxy-phenyl)-propane and 2,2-bis-(4-hydroxypropoxyphenyl)-propane (DE-A 2 407 674, 2 407 776 and 2 715 932).

The polyalkylene terephthalates can be branched if desired by incorporation of relatively small amounts of 3- or 4-hydric alcohols or 3- or 4-basic carboxylic acids, e.g. in accordance with DE-A 1 900 270 and U.S. Pat. No. 3,692,744. Examples of preferred branching agents are trimesic acid, trimellitic acid, trimethylolethane and -propane and pentaerythritol.

Polyalkylene terephthalates which have been prepared solely from terephthalic acid and reactive derivatives thereof (e.g. dialkyl esters thereof) and ethylene glycol and/or butane-1,4-diol and mixtures of these polyalkylene terephthalates are particularly preferred in some cases.

Mixtures of polyalkylene terephthalates contain preferably 1 to 50 wt. %, more preferably 1 to 30 wt. % of polyethylene terephthalate and preferably 50 to 99 wt. %, more preferably 70 to 99 wt. % of polybutylene terephthalate.

The polyalkylene terephthalates preferably used in general have a limiting viscosity of preferably from 0.4 to 1.5 dl/g, more preferably 0.5 to 1.2 dl/g, measured in phenol/o-dichlorobenzene (1:1 parts by weight) at 25° C. in an Ubbelohde viscometer.

The polyalkylene terephthalates can be prepared by known methods (see e.g. Kunststoff-Handbuch, volume VIII, p. 695 et seq., Carl-Hanser-Verlag, Munich 1973).

### Component E

The composition can comprise further optionally comprises one or more commercially available additives according to component E), such as flameproofing synergists, rubber-modified graft polymers which differ from component B), antidripping agents (for example compounds of the substance classes of fluorinated polyolefins, of silicones and aramid fibres), lubricants and mould release agents (for example pentaerythritol tetrastearate), nucleating agents, stabilizers, antistatics (for example conductive carbon blacks, carbon fibres, carbon nanotubes and organic antistatics, such as polyalkylene ethers, alkylsulfonates or polyamide-containing polymers), acids, fillers and reinforcing substances (for example glass fibres or carbon fibres, mica, kaolin, talc, CaCO₃ and glass flakes) and dyestuffs and pigments.

The graft polymers which differ from component B can be prepared by free-radical polymerization, e.g. by emulsion, suspension or solution polymerization. The compositions according to the invention are preferably free from graft polymers which differ from component B.

### Preparation of the Moulding Compositions and Shaped Articles

The thermoplastic moulding compositions according to the invention can be prepared, for example, by mixing the particular constituents in a known manner and subjecting the mixture to melt compounding and melt extrusion at temperatures of from 260° C. to 300° C. in conventional units, such as internal kneaders, extruders and twin-screw extruders.

The mixing of the individual constituents can be carried out in a known manner either successively and/or simultaneously, and in particular either at about 20° C. (room temperature) or at a higher temperature.

The invention likewise provides processes for the preparation of the moulding compositions and the use of the moulding compositions for the production of shaped articles and the mouldings themselves.

The moulding compositions according to the invention can be used, for example, for the production of all types of shaped articles. These can be produced for example, by injection moulding, extrusion and blow moulding processes. A further form of processing is the production of shaped articles by thermoforming from previously produced sheets or films.

Examples of such shaped articles include films, profiles, housing components of all types, e.g. for domestic appliances, such as televisions, juice presses, coffee machines and mixers; for office machines, such as monitors, flatscreens, notebooks, printers and copiers; sheets, tubes, electrical installation conduits, windows, doors and further profiles for the building sector (interior finishing and exterior uses) and electrical and electronic components, such as switches, plugs and sockets, and vehicle body or interior components for utility vehicles, in particular for the automobile sector.

The moulding compositions according to the invention can also be used in particular, for example, for the production of the following shaped articles or mouldings: interior finishing components for rail vehicles, ships, aircraft, buses and other motor vehicles, housing of electrical equipment containing small transformers, housing for equipment for processing and transmission of information, housing and lining of medical equipment, massage equipment and housing therefor, toy vehicles for children, planar wall elements, housing for safety equipment and for televisions, thermally insulated transportation containers, mouldings for sanitary and bath fittings, cover grids for ventilator openings and housing for garden equipment.

The following examples serve to explain the invention further.

### EXAMPLES

### Component A

Linear polycarbonate based on bisphenol A having a weight-average molecular weight M_{w} of 27,500 g/mol (determined by GPC).

### Component B

ABS polymer having a core-shell structure prepared by bulk polymerization of 82 wt. %, based on the ABS polymer, of a mixture of 24 wt. % of acrylonitrile and 76 wt. % of styrene in the presence of 18 wt. %, based on the ABS polymer, of a polybutadiene/styrene block copolymer rubber having a styrene content of 26 wt. %. The gel content of the ABS polymer is 24 wt. % (measured in acetone).

### Component C

### Component C-1 (Comparison)

Oligophosphate based on bisphenol A

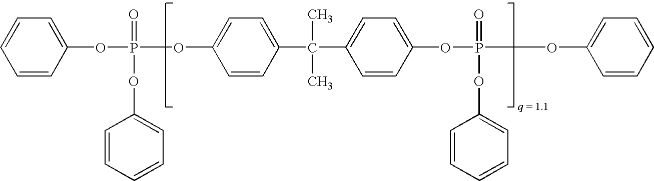

### Component C-2

Calcium phosphinate, average particle size d₅₀=50 μm.

### Component E

Component E-1: polytetrafluoroethylene (PTFE)
Component E-2: pentaerythritol tetrastearate
Component E-3: Irganox® B900 (manufacturer: Ciba Specialty Chemicals Inc., Basle, Switzerland)

### Preparation and Testing of the Moulding Compositions

The starting substances listed in Table 1 are compounded and granulated on a twin-screw extruder (ZSK-25) (Werner und Pfleiderer) at a speed of rotation of 225 rpm and a throughput of 20 kg/h at a machine temperature of 260° C. The finished granules are processed on an injection moulding machine to give the corresponding test specimens (melt temperature 240° C., mould temperature 80° C., melt front speed 240 mm/s).

Characterization is carried out in accordance with DIN EN ISO 180/1A (Izod notched impact strength a_{K}), DIN EN ISO 527 (tensile E modulus and elongation at break), DIN ISO 306 (Vicat softening temperature, method B with a load of 50 N and a heating rate of 120 K/h), ISO 11443 (melt viscosity), DIN EN ISO 1133 (melt volume flow rate MVR) and UL 94 V (measured on bars of dimensions 127×12.7×1.5 mm).

Hydrolysis test: The change in the MVR measured in accordance with ISO 1133 at 240° C. with a plunger load of 5 kg after storage (1 d=1 day, 2 d=2 days, 5 d=5 days, 6 d=6 days, 7 d=7 days) of the granules at 95° C. and 100% relative atmospheric humidity serves as a measure of the resistance to hydrolysis of the compositions prepared in this way. The MVR value before the corresponding storage is called “MVR value of the starting specimen” in Table 1.

Under the resistance to chemicals (ESC properties), the time until break at 2.4% edge fibre elongation after storage of the test specimen in toluene/isopropanol (60/40 parts by vol.) at room temperature is stated.

Compositions 3 and 4 according to the invention have an improved notched impact strength, improved Vicat heat distortion temperature, shorter after-burning time, better ESC properties, a higher E modulus and better elongation at break as well as a higher resistance to hydrolysis compared with Comparison Examples 1 and 5. This technical effect is attributed to the difference that an oligophosphate is employed as the flameproofing agent in the comparison examples.

Example 3 according to the invention differs from Comparison Example 2 in that the composition of Comparison Example 2 comprises a higher content of impact modifier B with the same amount of flameproofing agent. This difference has the technical effect that the composition of Example 3 according to the invention in particular has improved burning properties and a higher heat distortion temperature (Vicat B) compared with the composition of Comparison Example 2.

While the foregoing description teaches the principles of the present invention, with examples provided for the purpose of illustration, it will be understood that the practice of the invention encompasses all variations, adaptations, or modifications considered by those skilled in the art and encompassed by the following claims. As used herein and in the following claims, articles such as “a”, “an”, “the” can connote singular or plural.

TABLE 1
Compositions and their properties

| | | 1 | 2 | | | 5 |
|---|---|---|---|---|---|---|
| | | (comp.) | (comp.) | 3 | 4 | (comp.) |
| Composition | | | | | | |
| A | pt. by wt. | 90.0 | 79.9 | 90.0 | 84.9 | 84.9 |
| B | pt. by wt. | 5.0 | 15.1 | 5.0 | 5.0 | 5.0 |
| C-1 | pt. by wt. | 5.0 | | | | 10.1 |
| C-2 | pt. by wt. | | 5.0 | 5.0 | 10.1 | |
| E-1 | pt. by wt. | 0.4 | 0.4 | 0.4 | 0.4 | 0.4 |
| E-2 | pt. by wt. | 0.4 | 0.4 | 0.4 | 0.4 | 0.4 |
| E-3 | pt. by wt. | 0.1 | 0.1 | 0.1 | 0.1 | 0.1 |
| Properties: | | | | | | |
| aₖ (ISO 180/1A) 240° C./RT | kJ/m² | 9 | 29 | 21 | 18 | 6 |
| [brittle] | | | | | | |
| Vicat B 120 | ° C. | 125 | 137 | 142 | 142 | 112 |
| (ISO 306, DIN 53460) | | | | | | |
| Burning properties | | | | | | |
| (UL 94 V, 1.5 mm) | | | | | | |
| 2 d [rating] | | V0 | V1 | V0 | V0 | V0 |
| 2 d [total ABT] | s | 22 | 115 | 13 | 5 | 9 |
| 2 d [classification] | | 10/—/—/— | 5/5/—/— | 10/—/—/— | 10/—/—/— | 10/—/—/— |
| 7 d [rating] | | V0 | V1 | V0 | V0 | V0 |
| 7 d [total ABT] | s | 23 | 95 | 10 | 7 | 14 |
| 7 d [classification] | | 10/—/—/— | 6/4/—/— | 10/—/—/— | 10/—/—/— | 10/—/—/— |
| ESC properties/[2.4%] | rating | BR | BR | BR | BR | BR |
| | min:sec | 0:44 | 03:42 | 1:51 | 3:33 | 1:11 |
| Tensile test in accordance | | | | | | |
| with ISO 527 | | | | | | |
| Tensile E modulus | N/mm² | 2568 | 2750 | 2733 | 2889 | 2566 |
| Elongation at break (DR) | % | 55 | 100 | 102 | 104 | 31 |
| Hydrolysis test | | | | | | |
| (MVR 240° C./5 kg) | | | | | | |
| Starting specimen | cm³/10 min | 8.6 | 12.9 | 4.1 | 3.5 | 15.4 |
| Storage 1 d/95° C. | cm³/10 min | 9.6 | 13.3 | 4.2 | 3.7 | 20.8 |
| Storage 2 d/95° C. | cm³/10 min | 10.3 | 13.9 | 4.3 | 4.0 | 28.6 |
| Storage 5 d/95° C. | cm³/10 min | 13.7 | 14.9 | 5.4 | 4.8 | 87.5 |
| Storage 6 d/95° C. | cm³/10 min | 15.6 | 16.2 | 5.5 | 5.5 | >100 |
| Storage 7 d/95° C. | cm³/10 min | 17.4 | 17.8 | 5.7 | 6.1 | >100 |
| MVR increase on storage | | | | | | |
| relative to starting specimen | | | | | | |
| Storage 1 d/95° C. | % | 11 | 3 | 3 | 8 | 35 |
| Storage 2 d/95° C. | % | 19 | 8 | 7 | 16 | 86 |
| Storage 5 d/95° C. | % | 58 | 16 | 33 | 38 | 468 |
| Storage 6 d/95° C. | % | 81 | 26 | 35 | 58 | |
| Storage 7 d/95° C. | % | 101 | 38 | 40 | 75 | |

BR = break
ABT = after burning time

1. A compositions comprising
A) 58 to 99.6 parts by wt., in each case based on the sum of the parts by weight of components A+B+C, of an aromatic polycarbonate and/or an aromatic polyester carbonate,
B) 0.5 to 12 parts by wt., in each case based on the sum of the parts by weight of components A+B+C, of a rubber-modified graft polymer prepared by a bulk, solution and/or bulk-suspension polymerization process,
C) 0.1 to 30 parts by wt., in each case based on the sum of the parts by weight of components A+B+C, of a salt of a phosphinic acid.

2. Composition according to claim 1, comprising 3 to 8 parts by wt., in each case based on the sum of the parts by weight of components A+B+C, of a rubber-modified graft polymer according to component B.

3. Composition according to claim 1, comprising 7 to 12 parts by wt., in each case based on the sum of the parts by weight of components A+B+C, of a salt of a phosphinic acid.

4. Composition according to claim 1, comprising up to 20 parts by wt., based on the sum of the parts by weight of components A+B+C=100, of a rubber-free vinyl (co)polymer and/or a polyalkylene terephthalate as component D.

5. Composition according to claim 1 which is free from rubber-free vinyl (co)polymers and/or polyalkylene terephthalates.

6. Composition according to claim 1, comprising up to 50 parts by wt., in each case based on the sum of the parts by weight of components A+B+C=100 of an additive as component E.

7. Composition according to claim 1, comprising a graft polymer according to component B which is prepared by a bulk, solution and/or bulk-suspension polymerization process and has a rubber content, which corresponds to the content of component B.2 in the graft polymer of from 16 to 25 wt. %, and a grafted shell which comprises, in each case based on the monomers of the grafted shell, 22 to 27 wt. % of at least one monomer according to B.1.2, and 73 to 78 wt. % of at least one monomer according to B.1.1.

8. Composition according to claim 7, having a rubber content of from 17 to 19 wt. %.

9. Composition according to claim 7, wherein the graft polymer comprises a butadiene/styrene block copolymer rubber as a core and comprises a shell of styrene (B.1.1) and acrylonitrile (B.1.2).

10. Composition according to claim 1, comprising as component C, a salt or a mixture of salts of a phosphinic acid, wherein the metal cation of said salt or of at least one salt of said mixture of salts is Li⁺, Na⁺, K⁺, Mg²⁺, Ca²⁺, Sr²⁺, Ba²⁺, Al²⁺, Zn²⁺, Mn²⁺, Fe²⁺ and/or Fe³⁺.

11. Composition according to claim 10, comprising as the salt or as at least one salt of said mixture of salts, a phosphinic acid of the formula (IV) 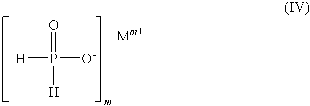
wherein
M^{m+} is a metal cation of main group 1, alkali metals; m=1, main group 2, alkaline earth metals; m=2, or of main group 3, m=3, or of subgroup 2, 7 or 8 of the periodic table, wherein m denotes an integer from 1 to 6.

12. Composition according to claim 11, wherein M^{m+}=Ca²⁺ and m=2 or M^{m+}=Al³⁺ and m=3.

13. Composition according to claim 1, wherein the average particle size d₅₀ of the phosphinic acid salt is not more than 80 μm.

14. Composition according to claim 13, wherein the average particle size d₅₀ of the phosphinic acid salt is from 10 to 55 μm.

15. Composition according to claim 1, wherein the composition is free from phosphorus-containing flameproofing agents selected from the group consisting of mono- and oligomeric phosphoric and phosphonic acid esters, phosphonate-amines and phosphazenes.

16. Composition according to claim 1, further comprising at least one additive, component E, comprising a flameproofing synergist, a rubber-modified graft polymer which differs from component B, an antidripping agent, a lubricant, a mould release agent, a nucleating agent, a stabilizer, an antistatic, an acid, a filler a reinforcing substance, a dyestuff and/or a pigment.

17. A method for the production of a shaped article comprising injection moulding, extrusion moulding, blow moulding processes, and/or thermoforming a composition of claim 1 to form said shaped article.

18. A shaped article comprising a composition according to claim 1.

19. A shaped article according to claim 18, wherein the shaped article is a part of a motor vehicle, rail vehicle, aircraft and/or aquatic vehicle.
